(19) United States
(12) Patent Application Publication
(10) Pub. No.: US 2010/0110127 A1
(43) Pub. Date: May 6, 2010

(54) Liquid Ejecting Apparatus And Control Method Of Liquid Ejecting Apparatus

(75) Inventor: Masako Fukuda, Siojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/606,040

(22) Filed: Oct. 26, 2009

(30) Foreign Application Priority Data
Oct. 27, 2008 (JP) 2008-275178
Oct. 13, 2009 (JP) 2009-236061

(51) Int. Cl. B41J 29/38

(52) U.S. Cl. 347/10

(57) ABSTRACT

A maintenance drive pulse group FL has a plurality of drive pulses DP1, DP2 including a first pulse elements P11, P21, a second pulse elements P12, P22, and a third pulse elements P13, P23, a first time width Pdis1 is set between a trailing edge of the third pulse element and a leading edge of the first pulse element of a next drive pulse, a voltage value of the drive pulses is set to 30 V or more, the first time period is set to a time period between 0.55 Tc and 0.75 Tc when a Helmholtz resonance period of an ink filled in a pressure generating chamber is assumed to be Tc, a second time width Pdis2 is set between a maintenance drive pulse group FL1 and another maintenance drive pulse group FL2 following the maintenance drive pulse group FL1, and the second time width is set to 20 times the first time width or more.

### BACKGROUND OF THE INVENTION

1. Field of the Invention

The present invention relates to a liquid ejecting apparatus including a liquid ejecting head such as an ink jet type recording head which ejects liquid from a nozzle opening, and a control method of the liquid ejecting apparatus.

2. Description of the Related Art

Liquid ejecting heads which discharge (eject) liquid as a liquid droplet from a nozzle opening by generating pressure change in the liquid in a pressure generating chamber include, for example, an ink jet type recording head (hereinafter simply referred to as “recording head”) used in an image recording apparatus such as an ink jet type recording apparatus (hereinafter simply referred to as “printer”), a color material ejecting head used to manufacture a color filter of a liquid crystal display or the like, an electrode material ejecting head used to form an electrode of an organic EL (Electro Luminescence) display, an FED (Field Emission Display), and the like, a bioorganic material ejecting head used to manufacture a biochip (biochemical element), and the like.

For example, in the recording head mentioned above, there is a risk that the recording head causes a trouble such as ink discharge failure by thickening and fixing of ink due to evaporation, pressure loss caused by a bubble mixed into ink which absorb the pressure change, and the like.

Various maintenance processings are performed to prevent such ink discharge failure. For example, a recording head is proposed in which thickened ink and a bubble mixed into ink are forcibly eliminated by driving a pressure generating element to provide pressure change in the pressure generating chamber and perform empty discharge of liquid droplets from the nozzle (hereinafter referred to as “flushing”) while the nozzle is capped and negative pressure is generated by a pump (for example, refer to Patent Document 1).

### [Prior Art Document]

### [Patent Document]

### [Patent Document 1] JP-A-2007-136989

### SUMMARY OF THE INVENTION

However, in the recording head described above, it is difficult to sufficiently eliminate the bubble because the pressure change is not sufficiently provided to a bubble having a minute diameter (for example, diameter of several tens of μm). On the other hand, depending on a waveform of a drive signal for driving the pressure generating element, a minute ink droplet called “satellite ink droplet” is generated following a main ink droplet, and the satellite ink droplet does not reach ink absorbing material and becomes a mist. There is a problem that the ink droplet which becomes the mist is scattered while flying in the air, and not only smears the inside of the printer, but also adheres to electronic components such as a circuit board to cause a failure such as a short circuit.

The present invention has been made in view of the above situation, and an object of the present invention is to provide a liquid ejecting apparatus which can eliminate a bubble mixed into liquid and discharge the liquid from a nozzle more stably, and a control method of the liquid ejecting apparatus.

### MEANS FOR SOLVING THE PROBLEM

To achieve the object, the liquid ejecting apparatus of the present invention is a liquid ejecting apparatus for ejecting liquid, and characterized by comprising:

a pressure generating chamber in which the liquid is filled;

a pressure generating element for changing a volume in the pressure generating chamber;

a nozzle connecting to the pressure generating chamber; and

a control section for generating a drive signal for controlling the pressure generating element,

wherein

the control section can generate a maintenance drive pulse group for discharging a bubble in the liquid from the pressure generating chamber,

the maintenance drive pulse group includes a plurality of drive pulses including a first pulse element for changing the volume of the pressure generating chamber to a first state by driving the pressure generating element, a second pulse element for maintaining the first state for a predetermined time period, and a third pulse element for changing the volume of the pressure generating chamber from the first state to a second state having a volume different from the volume of the first state, and a first time period is set between a trailing edge of the third pulse element and a leading edge of the first pulse element of a next drive pulse,

a voltage value of the drive pulses is set to 30 V or more,

the first time period is set to a time period between 0.55 Tc and 0.75 Tc when a Helmholtz resonance period of the liquid filled in the pressure generating chamber is assumed to be Tc,

a second time period is set between a maintenance drive pulse group and another maintenance drive pulse group following the former maintenance drive pulse group, and

the second time period is set to 20 times the first time period or more.

According to the above configuration, since the time period between the trailing edge of the third pulse element and the leading edge of the first pulse element of the next drive pulse is set as the first time period, and the first time period is set between 0.55 Tc and 0.75 Tc, the next drive pulse is applied to the pressure generating element at a timing when a free surface (meniscus) of the liquid in the nozzle is displaced toward the opposite direction to the fluid discharge direction by residual vibration after the fluid is discharged from the pressure generating chamber, so that, when the bubble mixed into the liquid are eliminated, a discharged liquid by a former drive pulse and a discharged liquid by a latter drive pulse are discharged in a state in which the former discharged liquid and the latter discharged liquid are linked to each other. Therefore, it is possible to prevent the discharged liquid from becoming a mist, and disadvantage that the misty liquid adheres to devices around the nozzle to cause a failure of the recording head, or the like can be reduced. As a result, the liquid can be stably discharged from the nozzle opening of the recording head, and the failure due to the mist does not occur. Here, the first state indicates a state in which the volume of the pressure generating chamber is different from a volume when the voltage is not applied to the pressure generating element, and means a state in which the voltage value is changed from an initial voltage value to a certain direction (for example, electricity charging direction). The second state indicates a state having a different volume of the pressure generating chamber from the volume in the first state, and means a state in which the voltage value is changed to the opposite direction to the certain direction (for example, electricity discharging direction).

Since the second time period is set between a maintenance drive pulse group and another maintenance drive pulse group following the former maintenance drive pulse group, and the second time period is set to 20 times the first time period or more, even when the drive pulse in the maintenance drive pulse group is set to a voltage higher than that of a normal discharge drive pulse, residual vibration generated by the maintenance drive pulse group can be sufficiently attenuated before the pressure generating element is driven by the next maintenance drive pulse group. As a result, the pressure generating element can be driven by the maintenance drive pulse group in a state in which the residual vibration is sufficiently attenuated, so that the bubble mixed into the liquid can be efficiently eliminated.

Further, in addition to the above, the control section may change the second time period in accordance with the number of the drive pulses included in the maintenance drive pulse group. According to the above configuration, even when the number of repetition times of the drive pulse included in the maintenance pulse group is changed and the residual vibration increases or decreases, the residual vibration is sufficiently attenuated independently of the number of repetition times of the drive pulse.

The control method of the liquid ejecting apparatus of the present invention is proposed to achieve the object describe above, and is a control method characterized by controlling drive of a pressure generating element,

in a liquid ejecting apparatus including:

a pressure generating chamber in which the liquid is filled;

a pressure generating element for changing a volume in the pressure generating chamber; and;

a nozzle connecting to the pressure generating chamber,

by providing a maintenance drive pulse group having a plurality of drive pulses including a first pulse element for changing the volume of the pressure generating chamber to a first state by driving the pressure generating element, a second pulse element for maintaining the first state for a predetermined time period, a third pulse element for changing the volume of the pressure generating chamber from the first state to a second state, and a first time period set between a trailing edge of the third pulse element and a leading edge of the first pulse element of a next drive pulse,

wherein

a voltage value of the drive pulses is set to 30 V or more,

the first time period is set to a time period between 0.55 Tc and 0.75 Tc when a Helmholtz resonance period of the liquid filled in the pressure generating chamber is assumed to be Tc,

a second time period is set between a maintenance drive pulse group and another maintenance drive pulse group following the former maintenance drive pulse group, and

the second time period is set to 20 times the first time period or more.

### BRIEF DESCRIPTION OF THE DRAWINGS

FIG. 1 is a perspective view of a printer;

FIG. 2 is an exploded perspective view of a recording head;

FIG. 3 is a plan view and a cross-sectional view of the recording head;

FIG. 4 is a block diagram illustrating an electrical configuration of the printer;

FIG. 5 is a waveform diagram illustrating a maintenance drive pulse group;

FIG. 6 is a schematic view illustrating behavior of a bubble in a pressure generating chamber;

FIG. 7 is an illustration explaining a relationship between a Helmholtz resonance period and a drive pulse;

FIG. 8 is a view showing an experimental result of discharge condition with respect to change of the drive pulse;

FIG. 9 is a view showing a relationship between a time width between the drive pulses and an applied voltage; and

FIG. 10 is a view showing a relationship between the time width between the drive pulses and the number of repetition times.

1 . . . printer, 12 . . . nozzle opening, 19 . . . piezoelectric element, 21 . . . pressure generating chamber, 46 . . . control section, DP1, DP2 . . . drive pulse, FL . . . maintenance drive pulse group, P11, P21 . . . first pulse element, P12, P22 . . . second pulse element, P13, P23 . . . third pulse element, Pdis1, Pdis2 . . . time width

### DESCRIPTION OF THE PREFERRED EMBODIMENTS

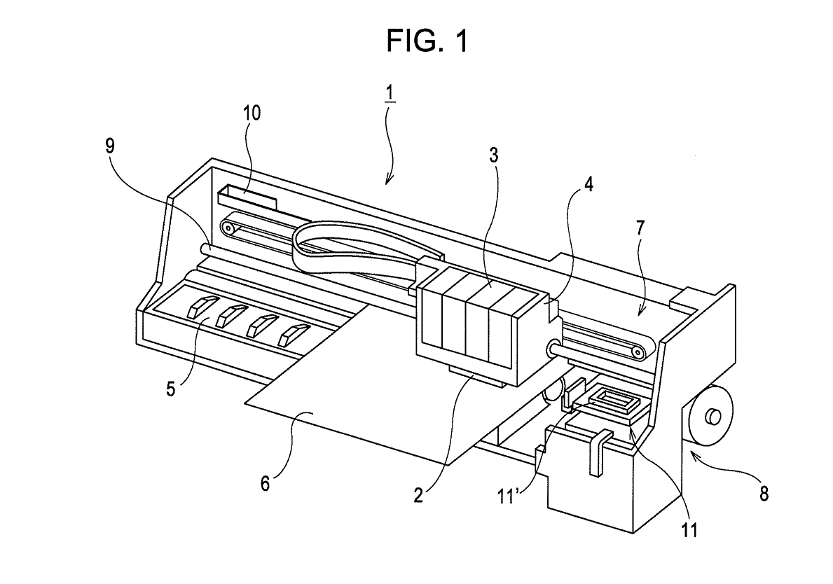

Hereinafter, preferred embodiments of the present invention will be described with reference to the accompanying drawings. Although, in the embodiments described below, there are various limitations as preferred embodiments of the present invention, the scope of the present invention is not limited to these embodiments unless there is a specific description that limits the present invention in the description below. Hereinafter, a case in which the liquid ejecting apparatus of the present invention is applied to an ink jet type recording apparatus (hereinafter abbreviate as printer) shown in FIG. 1 will be illustrated.

A printer 1 is schematically configured to include a recording head 2 which is a kind of a liquid ejecting head, the recording head being attached to the printer 1, a carriage 4 to which an ink cartridge 3 is attachably and detachably attached, a platen 5 arranged under the recording head 2, a carriage movement mechanism 7 for moving the carriage 4 on which the recording head 2 is mounted in a paper width direction of recording paper 6 (a kind of a discharge target or an ejection target), a paper transport mechanism 8 for transporting the recording paper 6 in a paper transport direction perpendicular to a head moving direction, and the like. Here, the paper width direction is a main scanning direction, and the paper transport direction is a sub-scanning direction. The ink cartridge 3 may be a type which is mounted on the carriage 4, or may be a type which is mounted on a housing of the printer 1 and from which an ink is supplied to the recording head 2 via an ink supply tube.

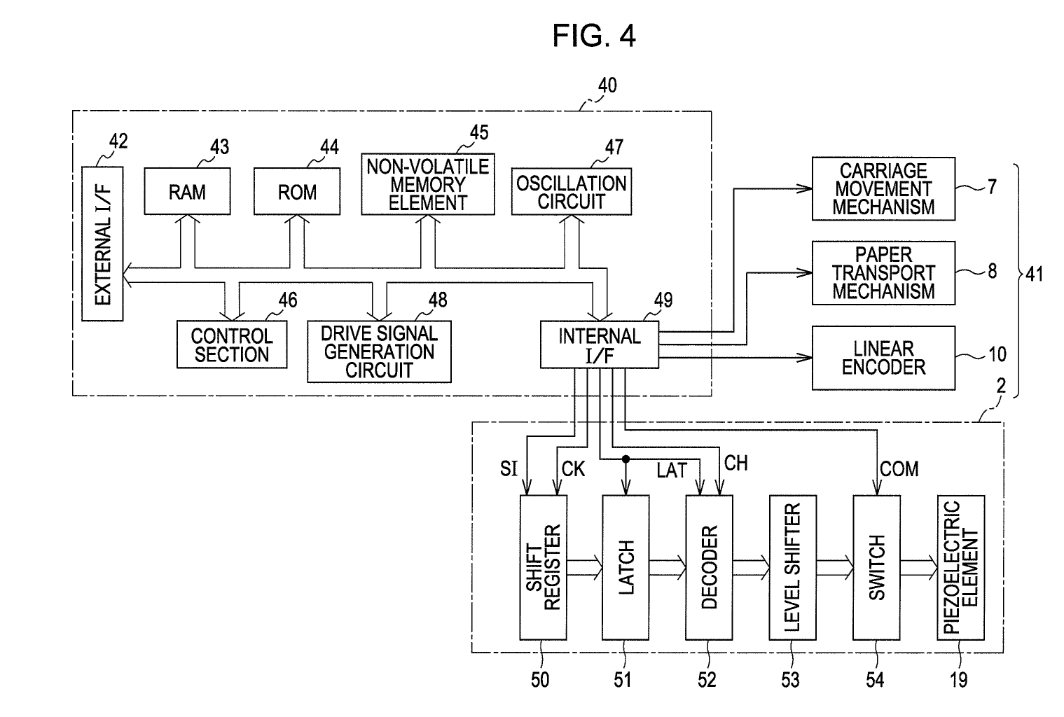

The carriage 4 is mounted on a guide rod 9 while being axially supported by the guide rod 9 installed in the main scanning direction, and configured to move in the main scanning direction along the guide rod 9 by the action of the carriage move mechanism 7. The position of the carriage 4 in the main scanning direction is detected by a linear encoder 10, and a detection signal is transmitted to a printer controller 40 (refer to FIG. 4) as position information. In this way, the printer controller 40 can control a recording operation (ink ejection operation) or the like of the recording head 2 while recognizing the scanning position of the carriage 4 on the basis of the position information from the linear encoder 10.

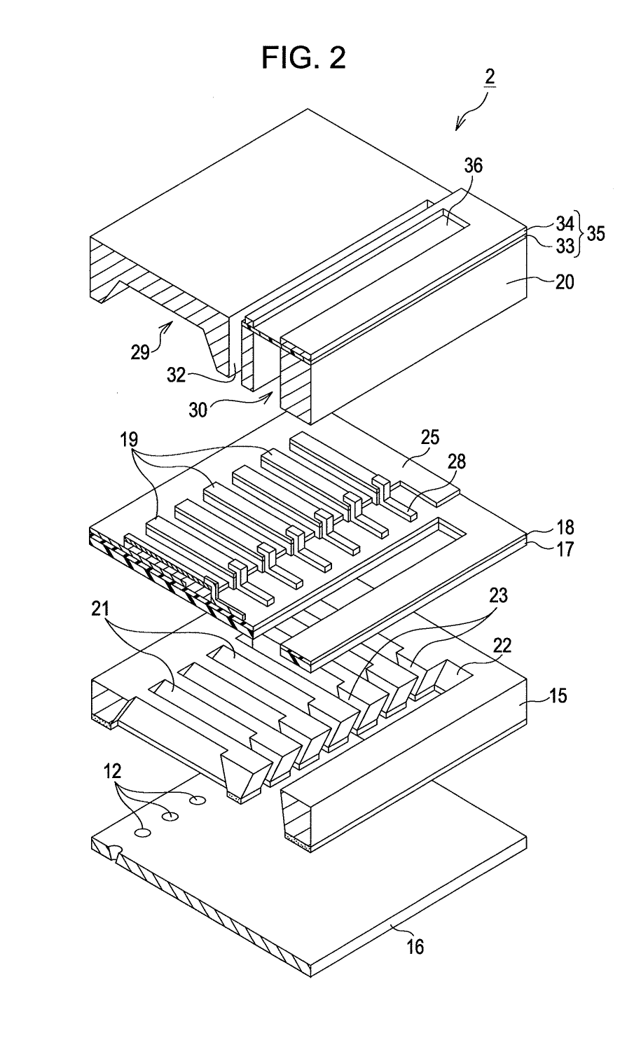

A home position which is a scanning start position of the recording head 2 is set in a moving range of the recording head 2 and outside of the platen 5. A capping mechanism 11 is provided at the home position. The capping mechanism 11 seals a nozzle surface of the recording head 2 by a cap member 11′, and prevents ink solvent from evaporating from a nozzle opening 12 (corresponding to the nozzle of the present invention, refer to FIG. 2). The capping mechanism 11 is used for a cleaning operation for eliminating a bubble mixed into the ink and a flushing operation described below for eliminating a thickened ink by providing negative pressure to the sealed nozzle surface to forcibly suction and remove the ink from the nozzle opening 12.

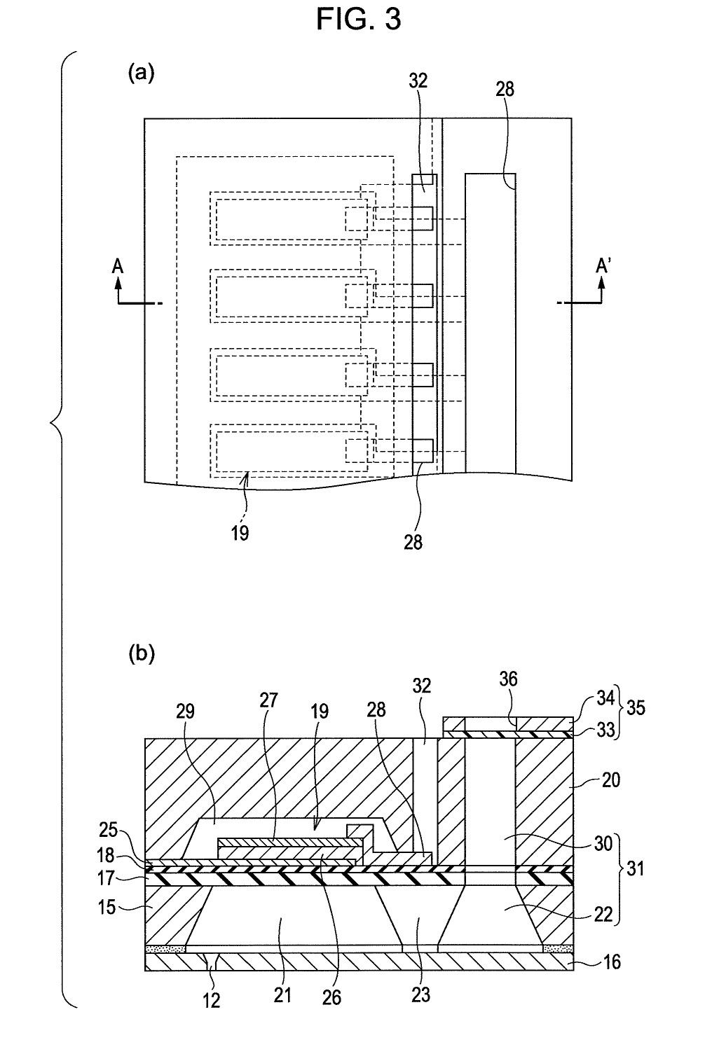

FIG. 2 is an exploded perspective view showing a configuration of the recording head 2, FIG. 3(a) is a plan view of the recording head 2, and FIG. 3(b) is a cross-sectional view taken along the line A-A′ in (a). The recording head 2 of the embodiment is configured by laminating a flow path forming substrate 15, a nozzle plate 16, an elastic body film 17, an insulating body film 18, a piezoelectric element 19 (corresponding to the pressure generating element of the present invention), a protective substrate 20, and the like.

The flow path forming substrate 15 is constituted by a silicon single crystal substrate in the embodiment, and a plurality of pressure generating chambers are aligned in a width direction of the flow path forming substrate 15. A connection section 22 is formed in an area outside in the longitudinal direction of the pressure generating chamber 21 of the flow path forming substrate 15, and the connection section 22 and each pressure generating chamber 21 are connected via an ink supply path 23 provided for each pressure generating chamber 21. The connection section 22 is connected to a reserver section 30 of the protective substrate 20 described below, and constitutes a part of the reserver 31 which is a shared ink chamber for each pressure generating chamber 21. The ink supply path 23 is formed to have a width narrower than that of the pressure generating chamber 21, and maintains a flow path resistance of the ink flowing into the pressure generating chamber 21 from the connection section 22 at a constant level.

A nozzle plate 16 in which nozzle openings 12 connected to an end portion in the opposite side of the ink flow path 23 of each pressure generating chamber 21 are provided in an open manner is fixed to an opening surface of the flow path forming substrate 15 via an adhesive material, a heat adhesive film, or the like, and each nozzle openings 12 connects to one of the pressure generating chambers 21 in an end portion in the opposite side of the ink supply path 23. The nozzle plate 16 includes a plurality of lines of the nozzle openings 12, and one nozzle line is constituted by, for example, 360 nozzle openings 12. The recording head 2 of the present invention is configured to be able to accommodate 4 ink cartridges each of which stores an ink (a kind of the liquid of the present invention) having a color different from one another, specifically stores inks of a total of 4 colors of cyan (C), magenta (M), yellow (Y), and black (K), and a total of 4 nozzle lines are formed in the nozzle plate 15 in accordance with these colors.

On the other hand, on the surface opposite to the opening surface of the flow path forming substrate 15, the elastic film 17 constituted by silicon dioxide (SiO₂) having a thickness of, for example, about 1.0 μm is formed, and the insulating body film 18 constituted by zirconium oxide (ZrO₂) having a thickness of, for example, about 0.4 μm is formed on the elastic film 17. On the insulating body film 18, a lower electrode film 25 having a thickness of, for example, about 0.2 μm, an piezoelectric body layer 26 (piezoelectric body film) having a thickness of, for example, about 1.0 μm, and an upper electrode film 27 having a thickness of, for example, about 0.05 μm are formed, so that, as a total, the piezoelectric element 19 (thin film piezoelectric element) having a thickness of 1.25 μm is constituted. Therefore, the piezoelectric element 19 is constituted by including the lower electrode film 25, the piezoelectric body layer 26, and the upper electrode film 27, using either one of the upper electrode and the lower electrode as a shared electrode, and performing patterning on the other electrode and the piezoelectric body layer 26 for each pressure generating chamber 21. A portion which is constituted by one of the electrodes and the piezoelectric body layer 26 on which the patterning is performed, and in which piezoelectric strain is generated by applying voltages to both electrodes is called a piezoelectric body active portion. Although, in the embodiment, the lower electrode film 25 is used as the shared electrode of the piezoelectric element 19, and the upper electrode film is used as individual electrodes of the piezoelectric element 19, for convenience of drive circuit and wiring, an opposite configuration of the above can be employed. In both cases, the piezoelectric body active portion is formed for each pressure generating chamber 21. A lead electrode 28 made of, for example, gold (Au) is connected to the upper electrode film 27 of each piezoelectric element 19 respectively, and a voltage is selectively applied to each piezoelectric element 19 via the lead electrode 28.

The protective film 20 including a piezoelectric element holding section 29 having a space, the size of which is enough so that the piezoelectric element holding section 29 does not block the displacement of the piezoelectric element 19 is connected to an area facing the piezoelectric element 19 on the surface of the side of the piezoelectric element 19 on the flow path forming substrate 15. Since the piezoelectric element 19 is accommodated in the piezoelectric element holding section 29, the piezoelectric element 19 is protected in a state in which the piezoelectric element 19 is hardly affected by an external environment. In addition, in the protective substrate 20, the reserver section 30 is provided in an area corresponding to the connection section 22 in the flow path forming substrate 15. The reserver section 30 is arranged along the alignment direction of the pressure generating chambers 21 while penetrating the protective film 20 in the thickness direction, and constitutes a reserver 31 to be a shared ink chamber for each pressure generating chamber 21 by being connected to the connection section 22 of the flow path forming substrate 15 as described above.

In an area between the piezoelectric element holding section 29 in the protective film 20 and the reserver section 30, a through-hole 32 penetrating the protective film 20 in the thickness direction is provided, a part of the lower electrode film 25 and a top portion of the lead electrode 28 are exposed in the through-hole 32, and an end portion of a wiring line from a drive IC not shown in the figures is electrically connected to the lower electrode film 25 and the lead electrode 28. A compliance substrate 35 constituted by a sealing film 33 and a fixing board 34 is bonded on the protective substrate 20. The sealing film 33 is made of a material having a low rigidity and a flexibility (for example, polyphenylene sulfide film having a thickness of 6 μm), and a surface of the reserver section 30 is sealed by the sealing film 33. The fixing board 34 is formed by a hard material such as a metal (for example, stainless steel having a thickness of 30 μm). Since an area facing the reserver 31 in the fixing board 34 is an opening portion 36 in which the fixing board 34 is completely removed in the thickness direction, a surface of the reserver is sealed by only the sealing film 33 having a flexibility.

In the recording head 1 of the above configuration, ink is taken from an ink supply means such as the ink cartridge, the inside from the reserver 31 to the nozzle opening 12 is filled with the ink, and thereafter, by providing a drive signal from the printer controller 40 of the printer main body, a voltage is applied between the lower electrode film 25 and the upper electrode film 27 corresponding to each pressure generating chamber 21 to bend the elastic film 17, the insulating body film 18, the lower electrode film 25, and the piezoelectric body layer 26, so that the pressure in the pressure generating chamber 21 is increased, and by controlling the pressure change, an ink droplet is ejected (discharged) from the nozzle opening 12 provided in an open manner in the nozzle plate 16.

FIG. 4 is a block diagram illustrating an electrical configuration of the printer 1. The printer 1 of the embodiment is schematically constituted by the printer controller 40 and a print engine 41. The printer controller 40 includes an external interface (external I/F) 42 from which print data or the like from an external apparatus such as a host computer is inputted, a RAM 43 for storing various data or the like, a ROM 44 storing a control program or the like for various controls, a non-volatile memory element 45 constituted by an EEPROM, a flash ROM, and the like, a control section 46 for performing an overall control of each section in accordance with the control program stored in the ROM 44, an oscillation circuit 47 for generating a clock signal, a drive signal generation circuit 48 for generating a drive signal provided to the recording head 2, and an internal interface (internal I/F) 49 for outputting dot pattern data obtained by developing the print data into each dot, the drive signal, and the like to the recording head 2.

The print engine 41 is constituted by the recording head 2, the carriage movement mechanism 7, the paper transport mechanism 8, and the linear encoder 10. The recording head 2 includes a shift register 50 in which the dot pattern data is set, a latch circuit 50 for latching the dot pattern data set in the shift register 50, a decoder 52 for translating the dot pattern data from the latch circuit and generating pulse selection data, a level shifter 53 functioning as a voltage amplifier, a switch circuit 54 for controlling supply of the drive signal to the piezoelectric element 19, and the piezoelectric element 19.

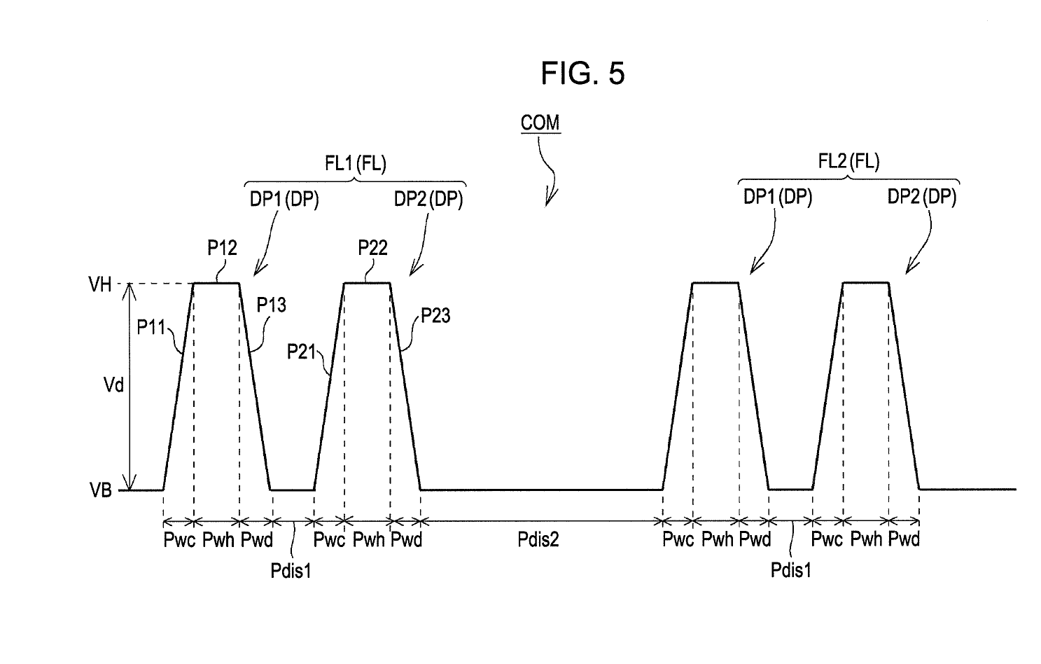

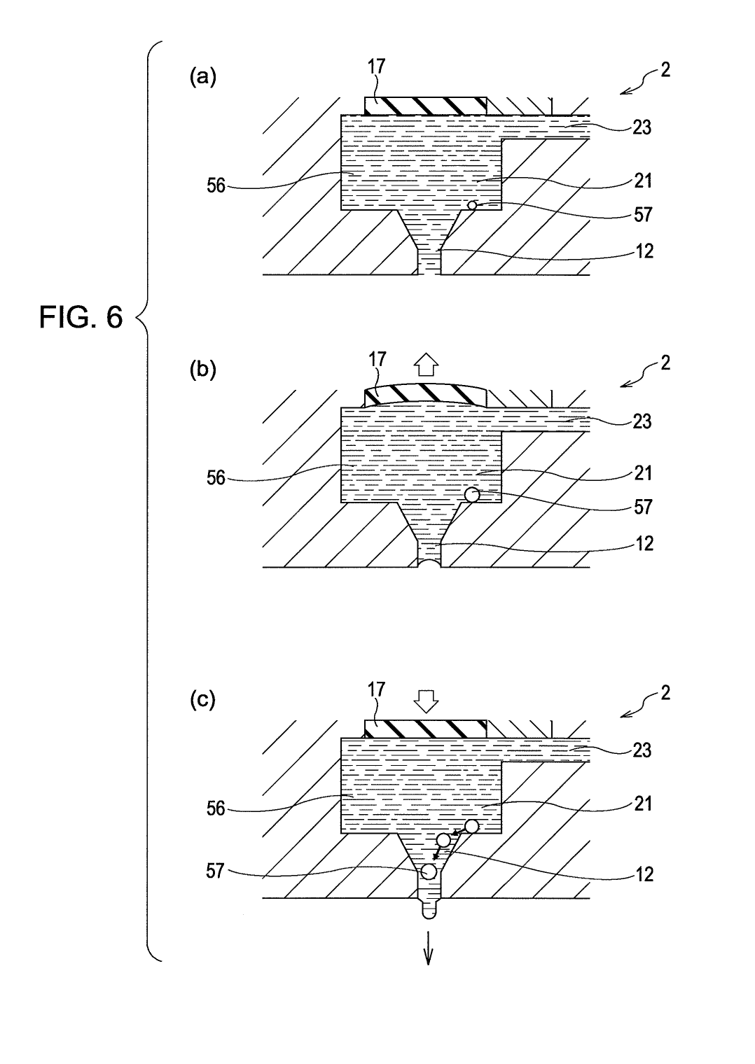

FIG. 5 is a waveform diagram illustrating a maintenance drive pulse group FL which is one of the drive signals generated by the drive signal generation circuit 48 in the above configuration. The control section 46 described above can generate a drive signal COM for controlling the piezoelectric element 19. The maintenance drive pulse group (flushing waveform group) FL illustrated in FIG. 5 is a drive pulse for discharging fluid including a bubble 57 (refer to FIG. 6) mixed into an ink 56 in the pressure generating chamber 21 when the flushing operation for discharging the thickened ink 56 (refer to FIG. 6) from the nozzle opening 12 is performed. The maintenance drive pulse group includes sets of a drive pulse DP1 and a drive pulse DP2, and the repetition of the drive pulse DP1 and the drive pulse DP2 constitutes the maintenance drive pulse group.

The drive pulse DP1 is a pulse signal having a generally trapezoidal shape as shown in FIG. 5, and constituted by a first pulse element P11 which raises the voltage from a base voltage VB to a highest voltage VH at a constant gradient in a time width Pwc, a second pulse element P12 which maintains the highest voltage VH that is a trailing edge voltage of the first pulse element P11 in a certain time period (time width Pwh), and a third pulse element P13 which lowers the voltage from the highest voltage VH at a constant gradient in a time width Pwd.

The drive pulse DP2 is constituted by generally the same waveform elements as those of the drive pulse DP1 described above, and generated later than the drive pulse DP1. The drive pulse DP2 is constituted by a first pulse element P21 which raises the voltage from the base voltage VB to the highest voltage VH at a constant gradient in a time width Pwc, a second pulse element P22 which maintains the highest voltage VH that is a trailing edge voltage of the first pulse element P21 in a certain time period in a time width Pwh, and a third pulse element P23 which lowers the voltage from the highest voltage VH at a constant gradient in a time width Pwd. A voltage difference between the lowest voltage VL and the highest voltage VH is a drive voltage (applied voltage) Vd[V].

FIG. 6 is a schematic view illustrating behavior of the bubble 57 in the pressure generating chamber 21. When the drive pulse DP1 or DP2 is provided to the piezoelectric element 19, the action below is performed. First, as shown in FIG. 6(a), in a state in which the bubble 57 is mixed into the ink 56 in the pressure generating chamber 21, when the first pulse element P11 or P21 is provided to the piezoelectric element 19, the piezoelectric element 19 convexly bends to the opposite side of the pressure generating chamber 21, and accordingly the pressure generating chamber 21 expands from a base volume corresponding to the base voltage VB to a maximum volume corresponding to the highest voltage VH (refer to FIG. 6(b)). Because of this first state, a negative pressure is generated in the ink 56 in the pressure generating chamber 21, and the meniscus exposed to the nozzle opening 12 is pulled toward the pressure generating chamber 21. The expanded state of the pressure generating chamber 21 is constantly maintained while the second pulse element P12 or P22 is provided. At this time, as the pressure in the pressure generating chamber 21 decreases, the diameter of the bubble 57 increases.

Following the second pulse element P12 or P22, when the third pulse element P13 or P23 is provided to the piezoelectric element 19, the piezoelectric element 19 is restored to a flat shape, so that the pressure generating chamber 21 contracts from the maximum volume to the base volume corresponding to the base voltage VB (refer to FIG. 6(c)). Because of this second state, the ink 56 in the pressure generating chamber 21 is given pressure from the elastic body film 17 and discharged from the nozzle opening 12. At this time, the bubble 57 whose diameter has been increased gradually approaches the nozzle opening 12 by an ink flow generated by the discharge of the ink 56, and finally discharged outside from the nozzle opening 12.

By the way, depending on the waveform of the maintenance drive pulse group FL constituting the drive pulses DP1 and DP2, by the volume change of the pressure generating chamber 21, a minute ink droplet called “satellite ink droplet” may be generated from the nozzle opening 12 following a main ink droplet, and there is a possibility that the satellite ink droplet becomes a mist. Therefore, in the maintenance drive pulse group FL of the present invention, the time width Pdis between the drive pulse DP1 and the drive pulse DP2 is appropriately set in accordance with the Helmholtz resonance period Tc which is a natural vibration period of the ink 56 (fluid) including the bubble 57 in the pressure generating chamber 21, so that the free surface (meniscus) of the ink 56 in the nozzle opening 12 is controlled. The Helmholtz resonance period Tc is a natural vibration period when a vibrational wave generated by the volume change of the pressure generating chamber 21 is transmitted to the ink 56 in the pressure generating chamber 21, and is a value determined by the shapes or the like of the nozzle opening 12, the pressure generating chamber 21, the ink supply path 23, and the like.

The Helmholtz resonance period (natural vibration period) Tc is a value determined by the shapes or the like of the nozzle opening 12 and the pressure generating chamber 21, and a vibration period Tc of the ink in the pressure generating chamber 21 is represented by the following formula.

Tc=2π√[((Mn×Ms)/(Mn+Ms))×Cc] (1)

In the formula (1), Mn is an inertance in the nozzle opening 12, Ms is an inertance in the ink supply path 23 connected to the pressure generating chamber 21, Cc is a compliance (volume change per pressure change, shows a degree of flexibility) of the pressure generating chamber 21. In the formula (1), the inertance M shows a mobility of the ink in the ink flow path, and is an ink mass per unit area of cross section. When the ink density is ρ, the cross-sectional area of the flow path perpendicular to the ink flow direction is S, and the length of the flow path is L, the inertance M can be approximately represented by the following formula (2).

Inertance M=(density σ×length L)/cross-sectional area S (2)

Tc is not limited to the above formula (1), and Tc may be a vibration period included in the pressure generating chamber 21.

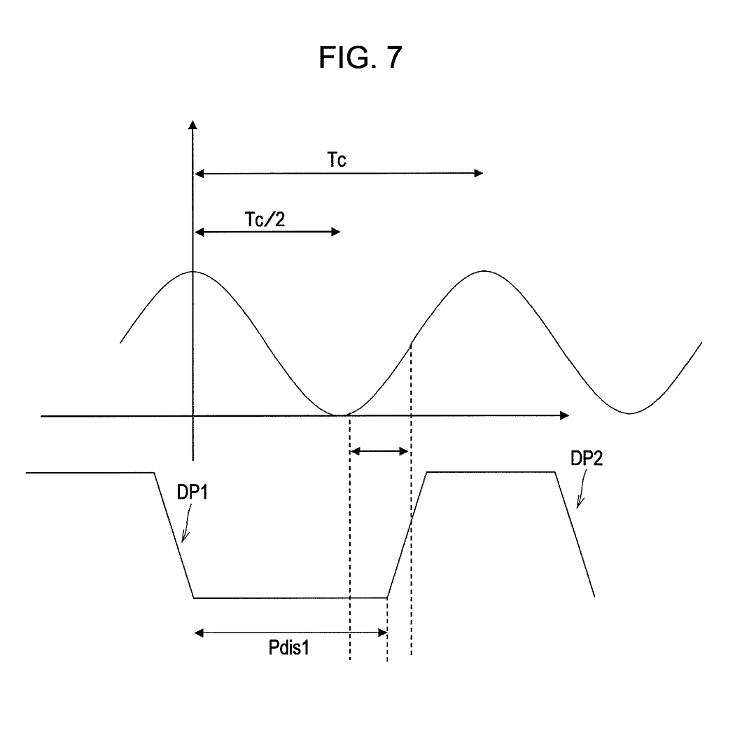

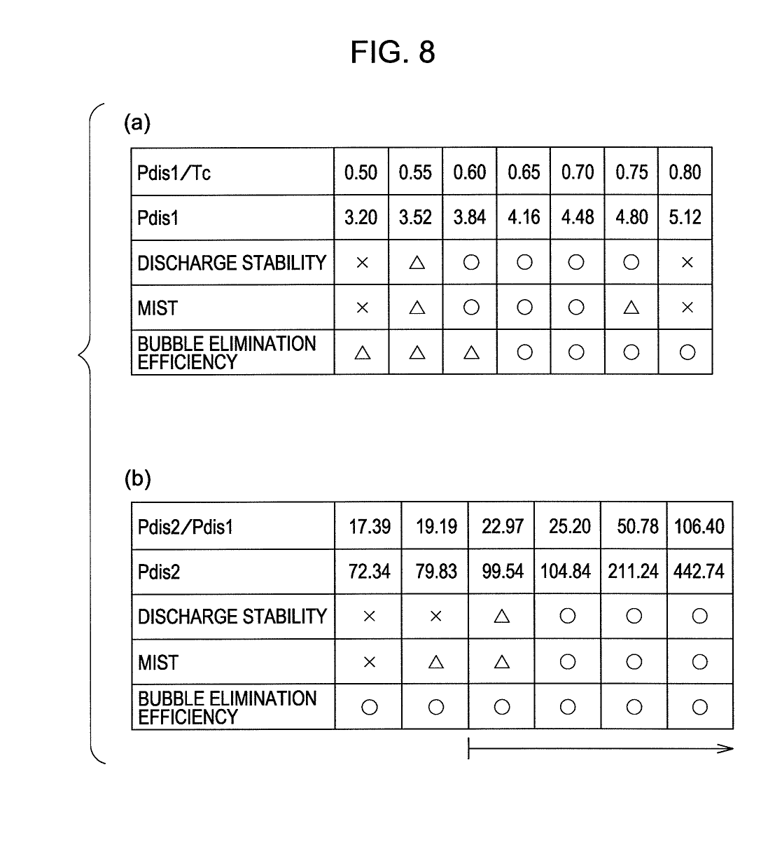

FIG. 7 is an illustration explaining a relationship between the Helmholtz resonance period Tc (upper part) and the drive pulses DP1 and DP2 (lower part). FIG. 8 is a view showing an experimental result of discharge condition with respect to the change of the drive pulse. Here, the interval between the trailing edge of the third pulse element P13 of the drive pulse DP1 of the maintenance drive pulse group FL and the leading edge of the first pulse element P21 of the drive pulse DP2 is defined as a time width Pdis1 (corresponding to the first time period of the present invention), and the trailing edge of the third pulse element P23 of the drive pulse DP2 and the leading edge of the first pulse element P11 of the drive pulse DP1 is defined as a time width Pdis2 (corresponding to the second time period of the present invention). The Helmholtz resonance period Tc which is the natural vibration period of the ink 56 (fluid) including the bubble 57 in the pressure generating chamber 21 is defined as Tc (for example, 6.4 [μm]). In the coordinate axes in FIG. 7, the horizontal axis shows a time progress and the vertical axis shows the position of the free surface (meniscus) of the ink 56 in the nozzle opening 12 so that the direction facing the back side (inside) of the nozzle opening 12 is the positive direction.

Here, the coordinate origin is a time point when the liquid is discharged, which is a first peak of the free surface (meniscus) and corresponds to the proximity of the third pulse element P13 of the drive pulse DP1. Although, FIG. 7 shows that the free surface moves in the same amplitude range even when the time passes, the amplitude decreases as the time passes because the amplitude practically attenuates.

FIG. 8(a) is the experimental result when the time width Pdis1 is changed in a state in which the time width Pdis2/Pdis1 is fixed to 100, and it is preferred that the time width Pdis1 is within a range between 0.55 Tc and 0.75 Tc as shown in the experimental result. FIG. 8(b) is the experimental result when the time width Pdis2 is changed in a state in which the time width Pdis1/Tc is fixed to 0.65, and it is preferred that the time width Pdis2 is 20 times the time width Pdis1 or more as shown in the experimental result. In FIG. 8, “◯” shows that approximately all the nozzle openings 12 have discharged successfully, “Δ” shows that the discharge of at least one nozzle opening 12 has failed at a probability of 30% or less, and “x” shows that the discharge of the nozzle opening 12 has failed at a probability of 50% or less.

Here, the fact that the time width Pdis1 is set within the range between 0.55 Tc and 0.75 Tc means that the next drive pulse DP2 is provided within a range depicted by dashed lines in FIG. 7, and the range corresponds to the time point when the free surface starts to move toward the back side.

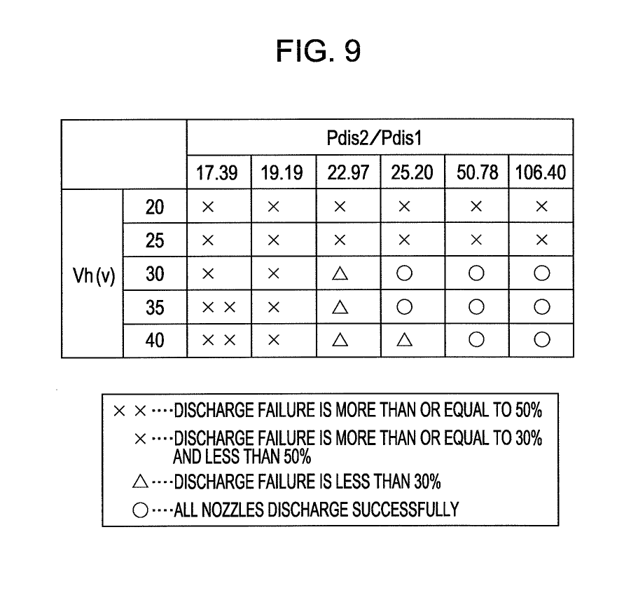

FIG. 9 is a view showing a relationship between the time width Pdis2/Pdis1 between the drive pulses DP and the applied voltage Vd[V] to the piezoelectric element 19. As shown in FIG. 9, it is preferred that the applied voltage (voltage value) of the drive pulse DP to the piezoelectric element 19 is set to 30 V or more, in addition to that the time width Pdis2 is set to 20 times the time width Pdis1 or more. Therefore, as shown in FIG. 9, it is known that, by providing the maintenance drive pulse group FL in which the time width of the drive pulse DP and the applied voltage are set within the above mentioned ranges to the piezoelectric element 19, the occurrence rate of the discharge failure can be reduced. In FIG. 9, “xx” shows that the discharge failure has occurred in 50% or more of all the nozzle openings 12, “x” shows that the discharge failure has occurred in more than or equal to 30% and less than 50% of the nozzle openings, “Δ” shows that the discharge failure has occurred in less than 30% of the nozzle openings, and “◯” shows that all the nozzle openings 12 have discharged successfully.

In summary, it is preferred that time width Pdis1 is within the range between 0.55 Tc and 0.75 Tc, and the time width Pdis2 is 20 times the Pdis1 or more. The time width Pdis1 and the time width Pdis2 may not be out of the above ranges.

When the applied voltage is low, the pressure change in the pressure generating chamber 21 decreases and the bubble discharge ability in the pressure generating chamber 21 decreases, so that the above described discharge failure of the nozzle opening 12 occurs. Therefore, as the applied voltage of the drive pulse DP to the piezoelectric element 19 increases, the pressure change in the pressure generating chamber 21 increases, so that the bubble discharge ability in the pressure generating chamber 21 can be improved. However, when the applied voltage increases, the residual vibration in the pressure generating chamber 21 also increases. Therefore, the time width Pdis2 of the drive pulse DP is set to 20 times the time width Pdis1 or more so that, in the maintenance drive pulse group FL of the present invention, after the residual vibration generated by applying the maintenance drive pulse group FL1 (indicated by a reference symbol FL1 in FIG. 5) to the piezoelectric element 19 attenuates, the timing when the next maintenance drive pulse group FL2 (indicated by a reference symbol FL2 in FIG. 5) is applied to the piezoelectric element 19 is set. In this way, the meniscus becomes a stable state, so that the discharge failure can be suppressed.

The time width Pdis1 and the time width Pdis2 are alternately set between the drive pulse DP1 and DP2, so that, at a timing when a free surface (meniscus) of the ink 56 in the nozzle opening 12 is displaced toward the opposite direction to the fluid discharge direction by the residual vibration after the fluid is discharged from the pressure generating chamber 21 by the drive pulse DP1, if the drive pulse DP2 is applied to the piezoelectric element 19 to contract the pressure generating chamber 21 again, the ink droplet discharged by the drive pulse DP1 and the ink droplet discharged by the drive pulse DP2 are discharged in a state in which the two ink droplets are linked to each other. This is considered that the ink droplets are attracted to each other by surface tension or the like. Because of this, so-called “ink trailing” in which an ink droplet (satellite ink droplet) generated following the discharged droplet flies is decreased, and the mist generation is suppressed. Therefore, it is possible to reduce failure of the recording head 2 or the like caused by the misty ink which adheres to devices around the nozzle opening 12. As a result, the ink 56 can be stably discharged from the nozzle opening 12 of the recording head 2, and the failure due to the mist does not occur. The time width Pdis2 is properly set to a value of 20 times the time width Pdis1 or more, so that the frequency of the drive signal COM can be changed.

Since the time width Pdis2 is set between the maintenance drive pulse group FL1 and the maintenance drive pulse group FL2 following the maintenance drive pulse group FL1, and the time width Pdis2 is set to 20 times the time width Pdis1 or more, even when the drive pulse DP in the maintenance drive pulse group FL is set to a voltage higher than that of a normal discharge drive pulse, the residual vibration generated by the maintenance drive pulse group FL1 can be sufficiently attenuated before the piezoelectric element 19 is driven by the next maintenance drive pulse group FL2. As a result, the piezoelectric element 19 can be driven by the maintenance drive pulse group FL2 in a state in which the residual vibration is sufficiently attenuated, so that the bubble mixed into the ink can be efficiently eliminated.

By the way, the present invention is not limited to the above embodiment, and various modifications are possible on the basis of the description of claims.

Although, in the above embodiment, an example in which the maintenance drive pulse group FL is configured to include sets of one drive pulse DP1 and one drive pulse DP2 is shown, the present invention is not limited to this, and the maintenance drive pulse group FL may be configured to include sets of two or more drive pulses DP.

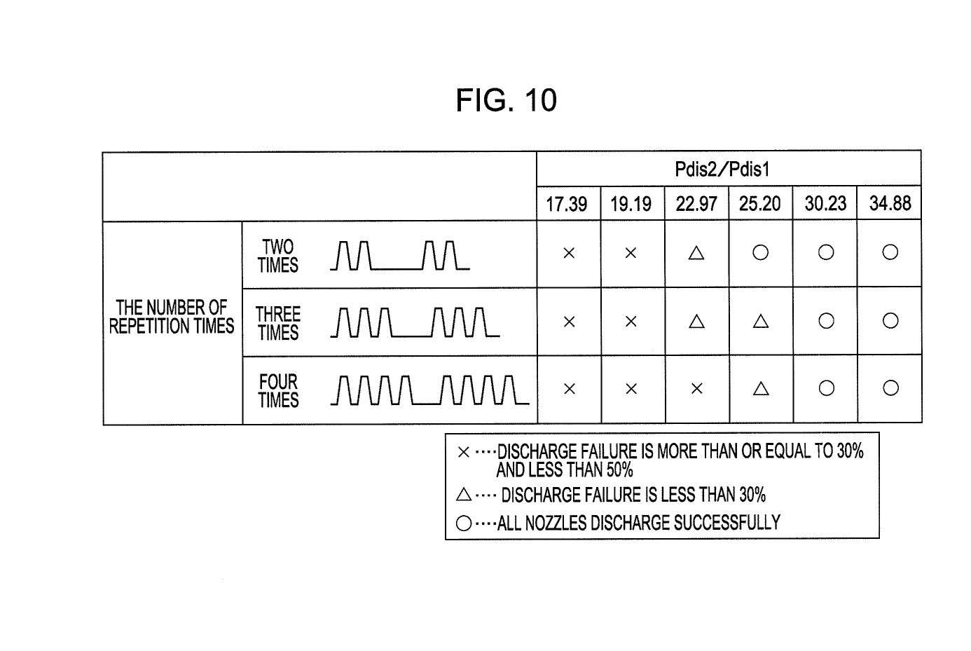

FIG. 10 is a view showing a relationship between the time widths Pdis2/Pdis1 between the drive pulses DP1 and DP2 and the number of repetition times of the drive pulse DP included in the maintenance drive pulse group FL.

Further, in the present invention, the time width Pdis2 may be changed in accordance with the number of the drive pulses DP included in the maintenance drive pulse group FL. For example, although, when the number of the drive pulses DP included in the maintenance drive pulse group FL is increased from 2 to 3, the residual vibration increases because the number of applied pressure changes increases, the residual vibration can be sufficiently attenuated by prolonging the time width Pdis2. In this way, by setting the time width Pdis2 in accordance with the number of the drive pulses DP included in the maintenance drive pulse group FL, the residual vibration can be sufficiently attenuated regardless of the number of the drive pulses DP.

Although, in the above embodiment, an example is shown in which the thin film piezoelectric element constituted by the lower electrode film 25, the piezoelectric body layer 26 (piezoelectric body film), and the upper electrode film 27 is used as the pressure generating element, the piezoelectric element of the present invention is not limited to this, and for example, a so-called flexural vibration mode piezoelectric element individually provided for each pressure generating chamber 21, a longitudinal vibration type piezoelectric element, or the like can be employed. The pressure generating element may be a magnetostrictor or the like, and also may be a heater element when using an ink generating a bubble.

Further, material and structure of each member are not limited to the above embodiment, and various configurations can be employed. Even when a different structure is employed, the maintenance drive pulse group FL may be determined on the basis of Tc of the structure.

Although, in the above embodiment, an ink jet type recording head mounted on an ink jet printer is illustrated, of course, the present invention can be applied to an apparatus which ejects liquid other than ink. Other liquid ejecting apparatuses include, for example, various recording heads used in an image recording apparatus such as a printer, a color material ejecting head used in a manufacturing apparatus of a color filter of a liquid crystal display or the like, an electrode material ejecting head used in an electrode forming apparatus for an organic EL display, an FED (Field Emission Display), and the like, a bioorganic material ejecting head used to manufacture a biochip, and the like.

What is claimed is:

1. A liquid ejecting apparatus for ejecting liquid, characterized by comprising:
a pressure generating chamber in which the liquid is filled;
a pressure generating element for changing a volume in the pressure generating chamber;
a nozzle connecting to the pressure generating chamber; and
a control section for generating a drive signal for controlling the pressure generating element,
wherein
the control section can generate a maintenance drive pulse group for discharging a bubble in the liquid from the pressure generating chamber,
the maintenance drive pulse group includes a plurality of drive pulses including a first pulse element for changing the volume of the pressure generating chamber to a first state by driving the pressure generating element, a second pulse element for maintaining the first state for a predetermined time period, and a third pulse element for changing the volume of the pressure generating chamber from the first state to a second state having a volume different from the volume of the first state, and a first time period is set between a trailing edge of the third pulse element and a leading edge of the first pulse element of a next drive pulse,
a voltage value of the drive pulses is set to 30 V or more,
the first time period is set to a time period between 0.55 Tc and 0.75 Tc when a Helmholtz resonance period of the liquid filled in the pressure generating chamber is assumed to be Tc,
a second time period is set between a maintenance drive pulse group and another maintenance drive pulse group following the former maintenance drive pulse group, and
the second time period is set to 20 times the first time period or more.

2. The liquid ejecting apparatus according to claim 1, characterized in that the control section changes the second time period in accordance with the number of the drive pulses included in the maintenance drive pulse group.

3. A control method characterized by controlling drive of a pressure generating element,
in a liquid ejecting apparatus including:
a pressure generating chamber in which the liquid is filled;
a pressure generating element for changing a volume in the pressure generating chamber; and;
a nozzle connecting to the pressure generating chamber,
by providing a maintenance drive pulse group having a plurality of drive pulses including a first pulse element for changing the volume of the pressure generating chamber to a first state by driving the pressure generating element, a second pulse element for maintaining the first state for a predetermined time period, a third pulse element for changing the volume of the pressure generating chamber from the first state to a second state, and a first time period set between a trailing edge of the third pulse element and a leading edge of the first pulse element of a next drive pulse,
wherein
a voltage value of the drive pulses is set to 30 V or more,
the first time period is set to a time period between 0.55 Tc and 0.75 Tc when a Helmholtz resonance period of the liquid filled in the pressure generating chamber is assumed to be Tc,
a second time period is set between a maintenance drive pulse group and another maintenance drive pulse group following the former maintenance drive pulse group, and
the second time period is set to 20 times the first time period or more.
